(19) United States
(12) Patent Application Publication
(10) Pub. No.: US 2002/0100527 A1
(43) Pub. Date: Aug. 1, 2002

(54) Tread pattern for a tire for heavy vehicles

(76) Inventors: Robert Radulescu, Perignat Les Sarlieve (FR); Pierre Zerlauth, Chateaugay (FR)

Correspondence Address: BAKER & BOTTS, 30 ROCKEFELLER PLAZA, NEW YORK, NY, 10112

(21) Appl. No.: 10/014,383

(22) Filed: Nov. 13, 2001

(30) Foreign Application Priority Data
Nov. 13, 2000 (FR) 00/14673

(51) Int. Cl. B60C 11/00

(52) U.S. Cl. 152/209.24; 152/209.18

(57) ABSTRACT

A tread for a tire has a tread pattern embodying a plurality of blocks which are defined by cutouts of longitudinal and transverse general orientation, each block having a contact face and lateral faces, the intersection of each lateral face with the contact face forming a ridge, the ridge(s) which is (are) first to come into contact forming the leading edge of the element, the lateral face intersecting the contact face along the leading edge constituting the leading face, a plurality of blocks having leading faces which a taper at an angle at most equal to 5°. Each block is provided with a plurality of wells opening on to the contact face of said block, the average direction of each well forming an angle β₁ at least equal to 10° with a line perpendicular to said contact face, the wells having average sections of between 0.2 and 12 mm².

### BACKGROUND OF THE INVENTION

The invention relates to tread patterns for tires and more particularly to treads for tires having a preferred direction of travel and intended in particular for use on heavy vehicles.

Experience shows that for treads for radial carcass tires for heavy vehicles comprising a plurality of blocks defined by grooves of circumferential and transverse general orientation. these blocks are subjected to sawtooth wear (so-called irregular wear, in that it develops preferentially in the vicinity of an edge of said blocks). This type of wear is particularly great on the treads of tires mounted on the driving axles of the vehicle, whether in individual or in twin mounting. By definition, a tread pattern block comprises an upper face intended to come into contact with the roadway during travel of the tire and lateral faces defining the grooves, each intersection of a lateral face with the upper face forming a ridge. The edge of the block, which is first to enter the contact zone, is called the leading edge: this edge may be formed by one or more ridges, the lateral face(s) defined by these ridges forming the leading wall. The edge of the block, which is last to emerge from the contact zone, is called the trailing edge and the lateral face to which it belongs is called the trailing wall of the block.

The irregular (sawtooth) wear, which is mentioned here, is manifested by greater wear localized on the contact face in the vicinity of the trailing edge.

To reduce this irregular sawtooth wear which is observed for tires fitted in particular on the driving axles of a heavy vehicle, there has been proposed in European Patent EP 0485778 a tread pattern comprising a plurality of blocks separated from each other by grooves of longitudinal and transverse orientation. One variant of embodiment set forth in this patent consists in providing for the faces of the blocks defined by the transverse grooves to form different angles (positive for the leading wall, negative—undercut—on the trailing wall) with a direction perpendicular to the running surface.

It has been observed that a positive taper angle on the leading wall was beneficial to the irregular wear and mainly to the development of this wear because, although slightly more pronounced wear appears on the trailing edge from the first kilometers onwards, the wear is then very regular over the entire block, whereas for tread patterns not having a dissymmetrical taper between the leading wall and trailing wall the wear is irregular, that is to say that it is more pronounced on the trailing edge than on the leading edge from the first kilometers onwards and that this difference in wear becomes accentuated greatly as the tire is used.

The implementation of such a solution with taper angles at least equal to 10° results in a substantial reduction in the volume available in each groove for evacuating water in the event of travelling during wet weather or on snow-covered ground. Furthermore, a taper angle greater than or equal to 10° results in a reduction in the width of the groove on the running surface of the tread as it becomes worn.

### SUMMARY OF THE INVENTION

The present invention is directed at producing a tread for a radial carcass tire intended to be fitted on a driving axle of a heavy vehicle which reduces the difference in wear between the leading edge and the trailing edge while maintaining a maximum groove volume. The present invention is also directed at a tire having a radial carcass reinforcement for heavy vehicles, comprising a tread according to the invention.

The tread according to the invention comprises a plurality of tread pattern elements, some of these tread pattern elements forming blocks which are defined by cutouts of longitudinal general orientation and cutouts of transverse general orientation, each block having an upper contact face and lateral faces, the intersection of each lateral face with the upper face forming a ridge, the ridge(s) which is (are) first to come into contact forming the leading edge of the element, the ridge(s) which is (are) last to emerge from the contact forming the trailing edge of the block. The lateral face or faces intersecting the upper contact face along the leading edge constitute, what is called the leading face(s); the lateral face or faces intersecting the upper contact face along the trailing edge constitute what is called the trailing face(s). A plurality of blocks have their leading face forming a taper angle at most equal to 5°, this angle corresponding to the angle formed by the leading face with a line perpendicular to the contact face when new and it is positive when the points of this face which are farthest to the inside of the thickness of the tread are, in the longitudinal direction, in front of the points of the same face on the leading edge when new.

Furthermore, each block, the contact face of which has a taper angle of at most 5° is provided with a plurality of wells opening on to the contact face of said block, the average direction of each well forming an angle β₁ at least equal to 10° with a line perpendicular to the contact surface of said blocks, the wells having average sections of between 0.2 and 12 mm²; the wells being arranged on at least one line oriented transversely relative to each block.

Preferably the depth of the wells is at least equal to 50% of the thickness of the blocks such that the beneficial effect on the wear is maintained for a major part of the period of use of the tread.

“Well” is understood to mean a hole of small section opening on to the contact face and extending over at least part of the thickness of each block, or indeed over at least 50% of the thickness of said block; these wells may in particular be formed at the time of molding the tread by means of molding elements mounted on the mold for said tread.

The average line of a well extends from the straight line passing through the center of mass of the cross-section of this well on the running surface when new of the tread and through the center of mass of the cross-section of this same well on the running surface after wear of the tread corresponding to 90% of the depth of the well.

Advantageously, and in accordance with preferred arrangements:

each well has a circular section of a diameter of between 1.5 mm and 2.5 mm (or of equivalent non-circular section) to avoid any risk of tearing of material during travel;

the minimum angular deviation between the orientation of the wells and that of the leading face of the blocks is at least equal to 10°;

the blocks have on their leading face zero taper angles (the leading face is perpendicular to the contact face of the block);

the wells have zigzag or undulating traces around their average line;

the wells of a block are distributed within the width of the block over several lines which are substantially parallel to each other, said wells being arranged in a staggered configuration from one line to the other;

the angle formed by the average line of a well is all the greater, the closer the well is to the leading face;

the total volume of the wells is between 0.1% and 5% of the total volume of the block without said wells (the extreme values being included);

the volume of the wells contained between a plane passing through the center of mass of the contact face, this plane being perpendicular to the contact face, and the leading face is greater than the volume of the wells between this same plane and the trailing face.

Advantageously, at least some of the blocks of the tread according to the invention may comprise, in addition to a first plurality of wells such as described, a second plurality of wells, the average direction of which forms an angle γ₁ at least equal to: 10° with a line perpendicular to the contact surface of said blocks, the wells having average sections of between 0.2 and 12 mm². The orientation selected for each of the wells of the second plurality means that these wells have a tendency, within the thickness of the block, to move away from an average plane of the block which passes through the center of mass of the contact face of said block.

Each well of the second plurality of wells is preferably made to open on to that part of the contact face lying between a plane perpendicular to the contact face and passing through the center of mass of the contact face and the trailing face. This second plurality of wells has a beneficial effect not on the irregular wear, but on the average rate of wear of the block which is evaluated as the ratio of the quantity of rubber worn for a given mileage.

Advantageously this second plurality of wells is produced symmetrically to the first plurality of<<ells of the tread pattern according to the invention.

Other characteristics and advantages of the invention will become apparent from the description given hereafter with reference to the appended drawings, which show, by way of non-limitative examples of embodiments of the invention.

### DESCRIPTION OF THE DRAWINGS

FIG. 1 shows in a plan view, a tread pattern according to the invention;

FIG. 2 shows a view along section II-II of FIG. 1 through the thickness of a block;

FIG. 3 shows a view along section III-III of FIG. 1 through the thickness of a second block;

FIG. 4 shows a sectional view IV-IV of FIG. 1 through the thickness of a third block;

FIG. 5 shows in section a block in accordance with the prior art;

FIG. 6 shows another variant of a block according to the invention; and

FIG. 7 shows a view along section VII-VII of FIG. 6 through a block.

### DETAILED DESCRIPTION OF THE INVENTION

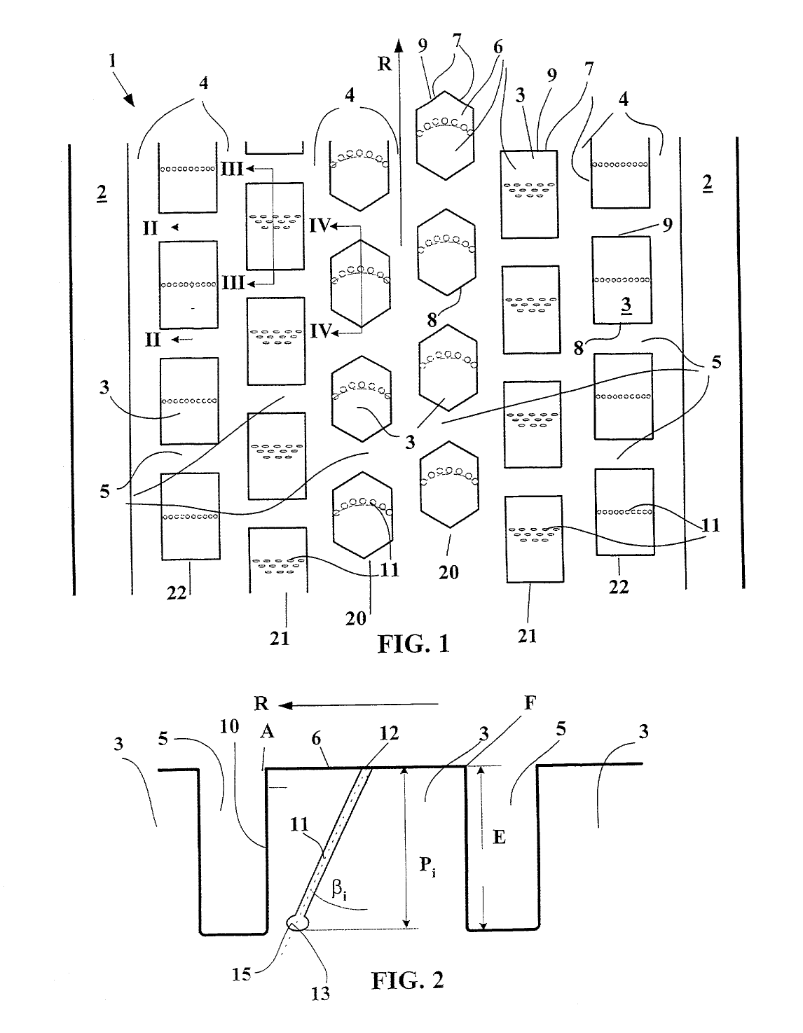

To simplify matters in FIGS. 1 to 7, the same references have been used to designate elements which are identical or of the same nature.

The tread 1 shown in FIG. 1 comprises two longitudinal ribs 2 arranged on the edges of this tread and six rows of blocks defined by longitudinal grooves 4 and transverse grooves 5. The blocks 3 of the two median rows 20 have contact surfaces 6 of 6-sided polygonal form, while the blocks 3 of the other rows 21, 22 have rectangular forms. The view shown in FIG. 1 is furthermore an artificial view of what the invention permits rather than a view of a single preferred variant, meaning that a particular arrangement may be used on its own or in combination with at least one other described arrangement; “arrangement” is understood to mean each of the variants described with the support of FIGS. 2, 3 and 4 corresponding to the sectional views in the thickness of the blocks of the different rows.

The arrow R indicates the preferred direction of travel.

Each of the blocks 3 is defined by grooves 4 of longitudinal orientations (that is to say circumferential on the tire fitted with this tread) of rectilinear general form and transverse grooves 5 opening into the longitudinal grooves 4. The upper contact face 6 of each of the blocks 3, which is visible in FIG. 1 and is intended to come into contact with the roadway during travel, is limited by ridges 7. The ridge which is first to come into contact with the roadway during travel constitutes the leading edge 9 of the block; the ridge longitudinally opposing this leading ridge corresponds to the last part of the contact face 6 to emerge from the contact and forms the trailing edge 8 of the block 3. The lateral face of the block 3 intersecting the contact face 6 along the leading edge 9 constitutes what is called the leading face, while the lateral face of the block 3 intersecting the contact face 6 along the trailing edge 8 constitutes what is called the trailing face.

In the particular case of the blocks of the central rows, the leading edge comprises the two ridges forming the front point of each of these blocks.

In FIG. 2, there can be seen in section along the line II-II in FIG. 1 a block 3 of the rows 22 which are close to the ribs 2 which block 3 is defined by transverse grooves 5; this block 3 has its leading face 10 which is perpendicular to the contact face 6 of said block. This block 3 comprises a plurality of wells 11 of substantially cylindrical shape of a diameter of 2.5 mm (of axis extending between points marked 12 and 13, the point 12 being located on the contact face 6 and the point 13 being within the block) and of a depth Pi equal to 24 mm (substantially equal to the depth E of the transverse grooves separating two blocks 3 of said rows 22), these wells 11 being arranged so as to be in one and the same plane inclined relative to a plane perpendicular to the contact face by a positive angle β₁ (that is to say in a plane inclined such that the points of said plane on the contact surface of the block are farther from the leading face than the points farthest to the inside of said block). The bottom of the well ends in a widened zone 15. In this FIG. 2 the point A corresponds to the intersection of the leading edge with the plane of the figure and the point F corresponds to the intersection of the trailing edge with this same plane.

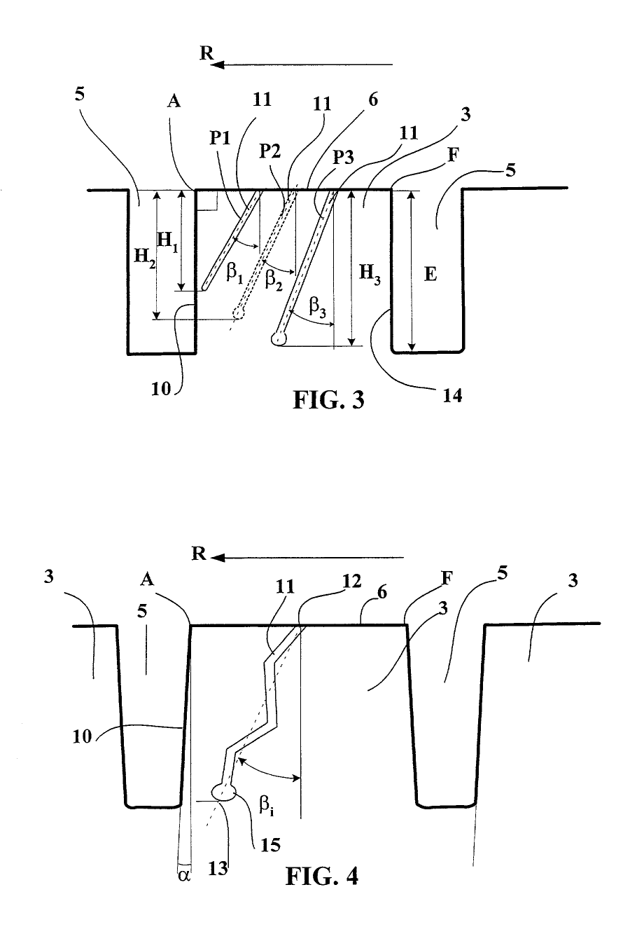

On the blocks 3 of the intermediate rows 21 as shown in section in FIG. 3, there are arranged alone straight lines parallel to the leading edge 9 a plurality of wells 11 the contour of which is of substantially elliptical shape. These wells 11 are arranged in a staggered configuration from one line to its neighbor so as to limit the reduction in longitudinal rigidity created by the presence of the same number of wells when these are distributed over a single transverse line as is the case for the variant corresponding to the blocks of the row 22 close to the rib 2 and to reduce the risks of tearing in the rubber constituting the block.

Advantageously, the wells 11 are arranged in three planes P1, P2, P3 oriented in the transverse direction of the block 3, these planes forming angles β₁, β₂, β₃ with a plane perpendicular to the contact surface of the block, these angles satisfying the following relationship:

β₁>β₂>β₃

The plane P1 is located between the plane P2 and the leading face; the plane P3 is located between the plane P2 and the trailing face.

On the other hand, the depths H1, H2, H3 respectively of the wells located on the planes P1, P2, P3 respectively satisfy the following relationship:

H1<H2<H3

and

H3=E

where E is the depth of the transverse grooves defining the block.

In FIG. 4, which shows a section through a block 3 of the median rows 20 along the line IV-IV, there can be distinguished a well 11, the average line of which forms an angle β₁ with a line perpendicular to the contact face. The leading face 10 has a taper angle α which here is equal to 3°. The trace of each well 11 has a zigzag shape around an average line passing through the points marked 12 and 13, the point 12 corresponding to the center of mass of the cross-section of the well on the contact face 6 when new and the point 13 corresponding to the point of the well farthest inside the block 3.

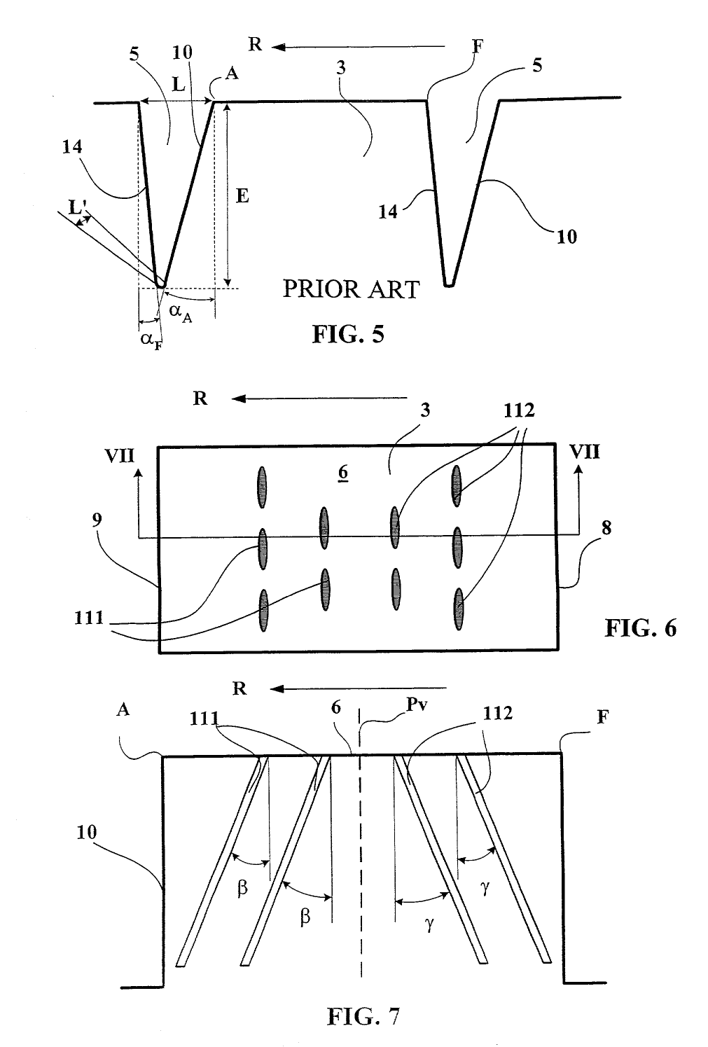

In the three examples described with FIGS. 2, 3 and 4, the volume of the transverse grooves is very largely greater than what is obtained with a solution of the prior art as shown in FIG. 5, in which two tread pattern blocks define, one with its leading face 10 forming a taper angle α_{A} of 15° and the other with its trailing face 14 forming a taper angle α_{F} of 5°, a groove 5 of depth E and the width of which decreases very substantially with the depth (this width is equal to L over the contact face when new and equal to L′ at the bottom of the groove).

In all the cases shown, the wells 11 end in widened parts 15 in order to avoid any problem of breaking at the bottom of the wells.

In FIG. 6 (showing the contact surface of a block) and FIG. 7 (showing a view in section along the line VII-VII in the thickness of the same block), there is shown a variant of a block 3 according to the invention comprising a first and a second plurality of wells. The first plurality of wells comprises wells 111 all oriented at the same angle β of 22° relative to a plane perpendicular to the contact face, all these wells 111 opening on to the contact face 6 between the leading face 10 of the block 3 and the plane Pv perpendicular to the contact face 6 and passing through the center of mass of said face. This first plurality of wells has a beneficial effect on the wear of the block by reducing the irregular wear which may appear on the trailing edge by reducing the risk of it appearing and/or being amplified if in spite of everything it were to appear.

The second plurality of wells comprises wells 112 arranged in a symmetrical pattern to the first plurality of wells, each of these wells 112 being oriented at an angle γ equal and opposed to the angle β in the variant described. This second plurality of wells has the function, when new, of compensating for the presence of the first plurality of wells in order to reduce the average rate of regular wear of the block; “average rate of regular wear” is understood to mean the loss of material by wear over the entire block related to the number of kilometers traveled.

The cross-sections of the wells 111, 112 of the first and second series of wells are sufficiently reduced (and preferably less than 6 mm²) in order to avoid as far as possible the penetration of various objects, in particular stones, which might reach the bottom of said wells and then attack the internal structure of the tire, as may be the case when each block is provided with incisions (that is to say cutouts of a width substantially equal to 0.6 mm and extending over at least 50% of the transverse width of the block).

Another advantage of the latter variant is that it is not necessary to assign a particular direction of travel to the tire equipped with such a tread having two pluralities of wells.

Of course, the invention is not limited to the examples described and shown, and various modifications can be made thereto by the person skilled in the art without departing from the scope thereof; likewise, this invention can readily be applied to any type of tire and in particular to any tire having irregular wear during travel.

We claim:

1. A tread for a tire, this tread comprising a plurality of tread pattern elements, some of these tread pattern elements forming blocks which are defined by cutouts of longitudinal general orientation and cutouts of transverse general orientation, each block having an upper contact face and lateral faces, the intersection of each lateral face with the upper contact face forming a ridge, the ridge(s) which is (are) first to come into contact with a road surface forming the leading edge of the block, the ridge(s) which is (are) last to emerge from the contact forming the trailing edge of the block; the lateral face or faces intersecting the upper contact face along the leading edge constituting the leading face(s); the lateral face or faces intersecting the upper contact face along the trailing edge constituting the trailing face(s); a plurality of blocks having leading faces having a taper angle at most equal to 5°, this angle corresponding to the angle formed by the leading face with a line perpendicular to the contact face when new, wherein each block, the contact face of which has a taper angle of at most 5°, is provided with a plurality of wells opening on to the contact face of said block, the average direction of each well forming an angle β₁, at least equal to 10° with a line perpendicular to the contact surface of said blocks, the wells having average sections of between 0.2 and 12 mm².

2. A tread according to claim 1, wherein some of the wells have surfaces of section which are equivalent to circular surfaces of a diameter at least equal to 1.5 mm and at most equal to 2.5 mm.

3. A tread according to claim 1, characterized in that the minimum angular deviation between the orientation of the wells and that of the leading face of the blocks is at least equal to 10°.

4. A tread according to claim 1, characterized in that the wells of at least one block are distributed within the width of said block over a plurality of lines substantially parallel to each other, said wells being arranged in a staggered configuration from one line to another.

5. A tread according to claim 1, wherein the total volume of the wells is between 0.1% and 5% of the total volume of the block.

6. A tread according to claim 1, wherein at least some of the blocks comprise another plurality of wells, the average direction of which forms an angle γᵢ at least equal to 10° with a line perpendicular to the contact face of said blocks, the sign of the angle γᵢ being opposed to the sign of the angle β₁, the wells having average sections of between 0.2 and 12 mm².

7. A tread according to claim 1, wherein the wells of at least one block have depths measured perpendicular to the contact face when new at least equal to 50% of a depth E of the transverse grooves.

8. A tread according to claim 1, wherein the wells have zigzag or undulating traces within the thickness of the tread.

9. A tread according to claim 1, wherein the taper angle of the leading face is zero.

10. A tire provided with a tread according to claim 1 and characterized in that it is intended to be fitted on a driving axle of a heavy vehicle.
